(19) United States
(12) Patent Application Publication
(10) Pub. No.: US 2011/0133648 A1
(43) Pub. Date: Jun. 9, 2011

(54) Toilet Illumination Apparatus

(76) Inventor: Scott Melton, Meza, AZ (US)

(21) Appl. No.: 12/786,418

(22) Filed: May 24, 2010

Related U.S. Application Data
(60) Provisional application No. 61/216,899, filed on May 22, 2009.

(51) Int. Cl. H05B 37/02

(52) U.S. Cl. 315/84

(57) ABSTRACT

A self contained lightweight device for providing night time illumination into a toilet bowl consists of an LED powered by internal battery enclosed in a small plastic housing. The device is designed to attach to the top of the bowl and beneath the toilet seat so that when the seat is lifted the light turns on. The light goes out when the seat is returned to the closed position or after a predetermined amount of time.

### CROSS REFERENCES TO RELATED APPLICATIONS

This non-provisional patent application claims a priority benefit to U.S. Provisional Application No. 61/216,899 entitled “Toilet Illumination Device” filed in the United States Patent and Trademark Office on May 22, 2009 by a common Inventor to this instant application, Scott Melton. Further the above named Provisional Application is hereby incorporated by reference.

### STATEMENT REGARDING FEDERALLY SPONSORED RESEARCH

Not Applicable

### REFERENCE TO APPENDIX

Not Applicable

### BACKGROUND OF THE INVENTION

It is a well known fact that many men or boys wander semi-consciously into the bathroom in the middle of the night to urinate. In their sleepy condition, they may not want to turn on the bright lights of the bathroom, so instead they make their way to the toilet under ambient light provided by a low power source such as a nightlight, or worst case no light at all. Under these demanding conditions, their aiming skills are known to be somewhat compromised so that the probability of depositing all of their waste fluids into the toilet is greatly diminished. This leads to an uncomfortable discussion the next day or sometime soon thereafter as to who will clean the bathroom and it injects unnecessary, unpleasant and unwanted discord into family relations. Also practically speaking, it also creates an unneeded cleanup requirement tasking precious family resources such as time and other more desirable leisure activities.

Thus there is a need for a low level illumination device that will assist a man or boy on a mission in the middle of the night to the bathroom. Such a device or convenience is heretofore unknown to the inventor. It will increase the odds of on target delivery and possibly even remove any collateral damage in some households. In general the device has potential for improving the quality of life for everyone in the household including the maid.

### FIELD OF THE INVENTION

This invention relates to light weight self contained illumination devices which can be installed securely in any location so as to provide low-level illumination automatically or on demand.

### BRIEF SUMMARY OF THE INVENTION

The invention is a self-contained illumination device for toilet bowl use at night or when there is a power outage, or in other dark places such as a porta-potty.

In a further embodiment, the illumination device can be used in other applications such as a reading light in a car or train or other common carrier.

### BRIEF DESCRIPTION OF THE DRAWINGS

FIG. 1 shows an exploded view of the toilet illumination invention device;

FIG. 2 is a cross-sectional perspective view of the invention device; and

FIG. 3 is a cross-sectional view of a toilet with the invention device installed under the seat.

### DETAILED DESCRIPTION OF THE EMBODIMENT

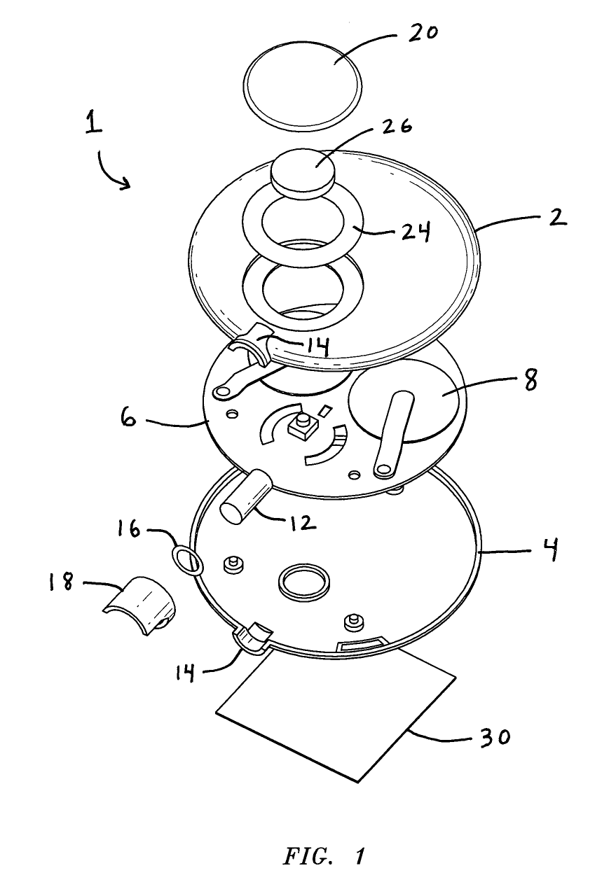

Now referring to FIG. 1 a first embodiment of the toilet illumination invention is shown 1. It consists of a two-piece enclosure; an upper housing 2 and a lower housing 4. Sandwiched between the two housings is a circuit board 6 with coin-shaped batteries 8, and an electrical switch 10. A low power blue LED 12 is mounted at a perimeter of the circuit board 6. The LED 12 will protrude through a neck like opening, a collar 14, formed by the two housings 2, 4. A small O-ring 16 mounts around the LED 12 to keep moisture out of the device by sealing the LED 12 in the neck like collar 14. Mounted on the formed collar 14 is a rotateable hood 18. It is a small plastic half-cylinder that snaps on to the collar 14 and can rotate as needed to direct the light.

A button 20 sits in a hole 22 in the top housing 2 to activate the switch 10 below. Another O-ring 24 seals the hole 22 by sitting between the button 20 and the upper housing 2 and further acts as a spring to return the button 20 to its most upright position and remove contact from the switch 10 below. A foam pad 26 also sits between the button 20 and switch 10.

Two coin-shaped batteries 8 are mounted in the circuit board 6 to provide power to the LED 12 and any other peripheral devices as mentioned in other embodiments below. In this first embodiment, the circuitry is simple. When the button 20 rises the switch 10 closes and provides electrical power to the LED 12. When the button 20 is depressed, it pushes the switch 10 down into an OPEN configuration and power is removed from the LED 12. The electrical switch 10 is a ‘normally closed’ switch. Thus when no pressure is pushing on the switch 10, it is closed and completes the electrical circuit.

The button 20 is activated by movement of the toilet seat 28 as will be shown and described in later figures and below.

The device 1 is easily installed by using a small square (2″×2″) of double-sided sticky tape 30. The square 30 is first applied the outside surface of the lower housing 4 and then the unit is attached to its final location with a small amount of manual pressure pushing the device against the surface of where it will reside such as the back of a toilet bowl 32.

The self-contained electrical system virtually removes the possibility of an electrical shock. Even if the unit 1 fell into the toilet 32, the only electricity flowing would be a small current from one side of a battery 8 to the other side conducted solely in the water.

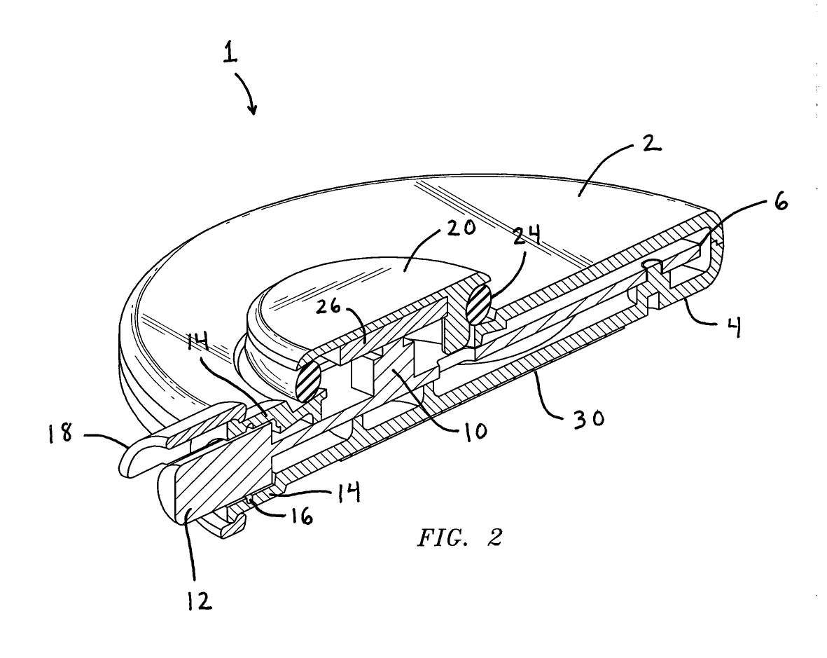

Now referring to FIG. 2 a cross-sectional perspective view of the toilet illumination device 1 is shown. The button 20 protrudes from the upper housing 2 and is sealed to the unit 1 by a large O-ring 24. The button 20 communicates through the foam pad 26 with the switch 10 below to activate the LED 12 when the toilet seat 28 is lifted. The hood 18 directs the light from the LED 12 downward into the toilet bowl 32 and also prevent the light from shining upwards and blinding someone urinating into the bowl 32. The circuit board 6 is sandwiched between the upper housing 2 and lower housing 4 and also contains the coin-type batteries 8. A small O-ring 16 seals the LED 12 to the collar 14 formed by the upper 2 and lower 4 housings.

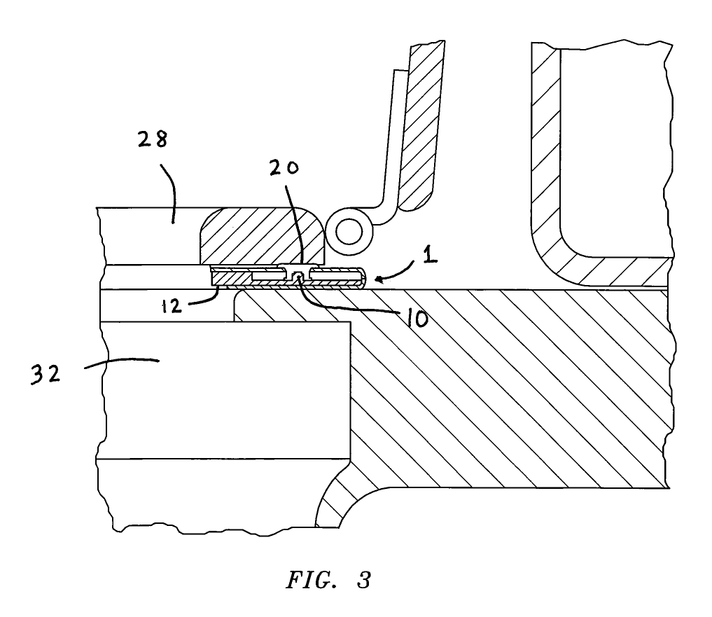

Now referring to FIG. 3 a cross-sectional elevation view of the toilet illumination device 1 is shown installed on a toilet bowl 32. The seat 28 in a lowered position makes contact with the button 20 compressing it downward so that the switch 10 is depressed. In this configuration the device 1 is in the OFF state and no light is emitted from the LED 12. However, once the seat 28 is lifted, the pressure is removed from the button 20 and the switch 10 is released into its upward position closing the electrical circuit between the batteries 8 and the LED 12. The LED 12 receives electrical power and generates light illuminating the toilet bowl 32. Thus the nightly visit by men to the toilet bowl is greatly enhanced by this low level light illuminating the target so that a mess is averted or minimized.

Automatic Shutoff

Another enhancement is the ‘auto-shutoff timer’ 34. Again it is well known that persons visiting the commode in the middle of the night are not truly awake or thinking clearly. As in the normal mode, the C2P device 1 is triggered ON by a lifting of the toilet seat 28, but our foggy patron may forget to put the seat 28 down (powers off the unit) once he or she has concluded their business. Thus with the seat 28 up the light 12 would run all night or until another more awake person put the seat 28 back down. This unnecessarily wastes battery 8 power and shortens the life of the battery 8 ultimately requiring frequent battery 8 replacement with the attendant purchase cost and time to perform such. The automatic shutoff circuit 34 can be set for a predetermined time of say 5 or 10 minutes for example. After the countdown timer reaches zero, the light 12 is extinguished and battery 8 power is conserved.

Light Sensor

Another enhancement is an integrated light sensor 36. There is no need to turn on the LED 12 in the middle of the day when there is plenty of ambient light or when our patron is fully awake and has turned on the normal bathroom lights. The light sensor 36 detects a predetermined level of ambient light and opens the power circuit separately from the power switch 10 so that even when the toilet seat 28 is lifted and the power switch 10 is closed, the light 12 does not illuminate and consume electrical power.

Rechargeable

Another embodiment of the invention 1 includes rechargeable battery 8 such as lithium-ion. The C2P light 1 can be recharged in several different modes.

A wall transformer (AC/DC) plugs into a C2P electrical socket and a C2P self contained charging circuit delivers power to the battery 8.

A wall charger with its own charging circuit delivers controlled voltage to a C2P electrical socket.

A first battery is designed to be removed and replaced with a second charged battery while the first battery is plugged into a charging block.

The electrical load and power configuration depends upon which feature set is implemented in the device 1. In the first embodiment, the unit 1 is designed to operated for a few months on replaceable batteries. Thus once these batteries expired, they are simply replaced with a fresh set of batteries.

Low Power Indication

In certain embodiments, a battery low power signal is emitted when the battery voltage falls below a predetermined level. That voltage is based upon the battery chemistry and voltage level of a quiescent fully charged battery.

A red flashing LED 38 can signal a low voltage condition.

An occasional audio chirp may be played to alert a homeowner of a low voltage condition.

Both audio and visual cues may be provided in the low voltage mode.

Audio Circuit

An inexpensive speaker 40 can be provided in the device 1 to provide audible alarm signals for various conditions such as low voltage or in the child safety mode.

Radio Frequency Communications

Bluetooth

A Bluetooth transmitter circuit 42 can be provided to send a status signal to a remote receiver 44. A ‘toilet seat OPEN’ signal would be received and processed so as to alert a homeowner of an unsafe condition such as a child playing in the bowl which can include a disease risk or a risk of drowning.

Using Bluetooth technology would be an advantage where multiple devices were operation in the same building or household.

Simple RF

A simple RF signal could be transmitted and received. This would eliminate the complexity and expense of a more complex technology like Bluetooth.

Proximity Detection

Another mode of operation would be if the child wore an RFID bracelet 46 and the C2P device 1 included sensors 48 for such. If the child came within range of the C2P 1, then the audible and flashing LED 38 alarms would be activated.

Infra-Red (IR) Sensor

An IR sensor 50 allows the unit 1 to sense the coming and going of a person. If the person comes and leaves and the unit 1 detects no flushing noise, a polite voice can speak a reminder to the bathroom visitor such as “Please flush the toilet if you are done . . . Thank you!”

Child Safety Mode

When set in this mode the unit 1 emanates a loud continuous chirp and or flashing red LED 38 so a parent, babysitter or adult knows that the toilet seat 28 has been lifted and a child maybe exposed to unnecessary health risks or drowning.

I claim:

1. A device for providing illumination into a toilet bowl comprising:
a light connected to a controllable power source;
a sensor for detecting motion of a toilet seat cover;
a self contained battery for selectably providing electrical power to the light;
said sensor connecting said battery to said light upon sensing the opening of said toilet seat cover; and
said sensor disconnecting said battery from said light upon sensing the closing of said toilet seat cover.
